(19) United States
(12) Patent Application Publication
(10) Pub. No.: US 2007/0157430 A1
(43) Pub. Date: Jul. 12, 2007

(54) Furniture or iron fitting

(76) Inventor: Horst Lautenschlager, Reinheim (DE)

Correspondence Address: WRB-IP LLP, 1217 KING STREET, ALEXANDRIA, VA, 22314, US

(21) Appl. No.: 10/597,757

(22) PCT Filed: Jan. 19, 2005
(86) PCT No.: PCT/EP05/00467

§ 371 Date: Aug. 7, 2006

(30) Foreign Application Priority Data
Feb. 10, 2004 (DE) 10 2004 006 330.3

(51) Int. Cl. E05D 7/04

(52) U.S. Cl. 16/245

(57) ABSTRACT

A threaded sleeve (8) that is connected with the second fitting part (2) is engaged with the threaded spindle (5) between both bearings (6, 7), so as to be adjusted axially. The threaded spindle (5) is axially supported on both ends in opposite directions on allocated bearing (6, 7) in each case and an adjustment of the elevation of both fitting parts (1, 2) is made possible.

The invention pertains to a furniture or structural fitting for connecting two furniture components or structural components. As a result of the connection of the two parts by the furniture or structural fitting, their orientation is, at the same time, established in the vertical direction. In many cases, it is necessary to undertake a vertical orientation, especially an adjustment in terms of elevation, of one structural component relative to the other structural component, even after applying a connective fitting. Examples of this include the adjustment of a door's elevation relative to the doorframe or casement, or the orientation of a front plate on a drawer or on the body of a piece of furniture.

It is the task of the invention, therefore, to create a furniture or structural fitting which renders simple relative repositioning possible, particularly adjustment in terms of elevation, in conjunction with simple construction and low spatial requirements, between those furniture or structural components that are connected by the fitting.

This task is resolved in keeping with the invention by a furniture or structural fitting comprising a first fitting part and a second fitting part connected to the former by way of an elevation adjustment apparatus, such that on the first fitting part, a threaded spindle is seated on two bearings arranged at some distance from one another so as to be capable of rotation, but incapable of an axial position adjustment, such that a threaded sleeve that is connected to the second fitting part is engaged with the threaded spindle between both bearings so that its position can be adjusted axially, and the second fitting part, which exhibits the threaded sleeve, is guided by a longitudinal guiding apparatus on the first fitting part so as to be incapable of rotating.

By rotating the threaded spindle, both fitting parts undergo a positional readjustment relative to one another in the axial direction so that a relative adjustment of the elevation of two furniture components or structural components, which are connected to both fitting parts, is rendered possible.

The spatial requirements of the elevation adjustment apparatus obtained in this way are relatively slight because both the two bearings of the threaded spindle as well as the threaded sleeve can be embodied so as to be relatively thin. The elevation adjustment apparatus according to the invention can thus be provided even on flat fitting parts, preferably without exceeding their thickness appreciably.

Due to the fact that the second fitting part, which exhibits the threaded sleeve, is guided by a longitudinal guiding apparatus on the first fitting part in such a way as to be incapable of rotating, the orientation of both structural components to be connected relative to one another is retained—if this is desired—while the elevation is adjusted.

A particularly advantageous developmental extension of the thought behind the invention is characterized in that in the process, the second fitting part is connected, so as to be capable of rotating, to an attachment plate by a hinge having a hinge axis that runs parallel to the axis of the threaded spindle. In this manner, a hinge is obtained that can be used, for example, as the hinge of a door, which also renders an adjustment of the elevation of both parts connected by the hinge, relative to each other, possible, for example, the adjustment, in terms of elevation, of a door hung on a doorframe or casement by such hinges.

The threaded spindle is preferably supported axially at both ends in opposite directions at the allocated bearing in each case. By this, the axial forces and flexion forces on the second fitting part are introduced, by way of the threaded sleeve, to the first fitting part in an advantageous manner, without imposing a great load, especially flexion stress, on the threaded spindle by so doing. The threaded spindle can therefore be embodied so as to be relatively slender.

In order to execute the axial support of the threaded spindle at both bearings in a simple manner from the standpoint of construction and production technology, and in order to take up just little space for the purpose, provision is made in extension of the thought behind the invention so that the threaded spindle exhibits a thickened head at both ends outside the individual bearing. For turning the threaded spindle, provision is made, preferably, so that one of the two heads of the threaded spindle exhibits the profile of a wrench projection, for example, an internal hexagonal profile, a cross slit, or a transverse slit. What is achieved with this is that the adjustment can be accomplished with a simple tool that is widely available, namely a screwdriver. Other advantageous embodiments of the thought behind the invention are the subject matter of additional subsidiary claims.

### BRIEF DESCRIPTION OF THE DRAWINGS

Following are embodiment examples of the invention, which are represented in the drawing, elucidated in greater detail.

FIG. 1 shows a furniture or structural fitting, which is embodied as a door hinge whose elevation can be adjusted, from the front, and

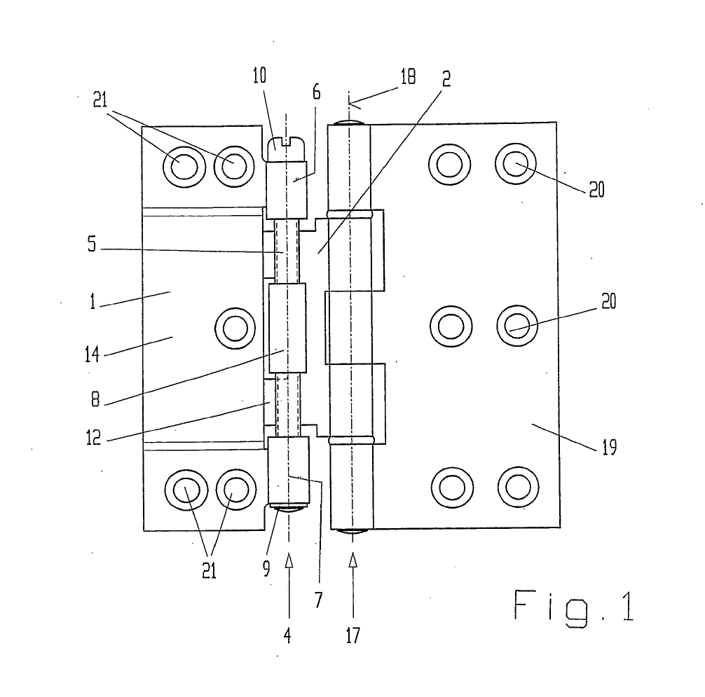

FIG. 2 shows the fitting according to FIG. 1, from the back.

### DETAILED DESCRIPTION

The furniture or structural fitting that is depicted exhibits a first fitting part 1 and a second fitting part 2. Both fitting parts 1 and 2 are connected with one another by way of an elevation adjustment apparatus 4 so as to be longitudinally adjustable. On the first fitting part 1, a threaded spindle 5 is seated in two bearings 6 and 7, which are embodied on the first fitting part 1 as coaxial sleeves and are arranged at some distance from one another so as to be capable of rotation, but incapable of axial repositioning.

A threaded sleeve 8, which is connected to the second fitting part 2 as one piece, is arranged in alignment between both bearings 6, 7 and it exhibits internal threading, by-which it is engaged with the threading of the threaded spindle 5.

The threaded spindle 5 is equipped at both its ends, outside the individual bearing 6 or 7, respectively, with a thickened head 9 or 10, respectively. The threaded spindle 5 is supported in the axial direction at the bearings 6, 7 by both heads 9, 10.

One head 10 exhibits a transverse slit 11 as a wrench projection profile in the embodiment example that is shown, which renders it possible to turn the threaded spindle 5 by a screwdriver. By this, a relative adjustment of both fitting parts 1, 2 occurs in the axial direction of threaded spindle 5, and thus, a relative adjustment of the elevation of the two furniture parts or structural components connected therewith.

The embodiment example of a furniture or structural fitting that is shown represents a hinge, for example, the hinge of a door.

The two fitting parts 1, 2 are guided so as to be incapable of rotating, one relative to the other. For this purpose, a longitudinal guiding apparatus is provided, which, in the case of the embodiment example that is depicted, exhibits a guide plate 12 that is rigidly connected to the second fitting part 2, which is accommodated in a flat pocket 13 formed by the first fitting part 1, so that its longitudinal position can be adjusted.

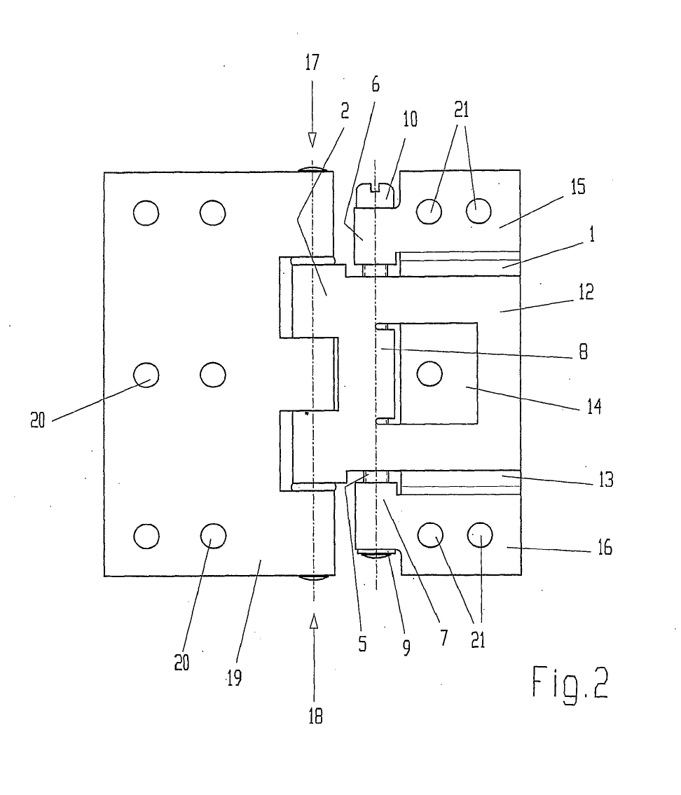

As one recognizes from the back view in FIG. 2, the pocket 13 is formed between a central section 14 of the first fitting part 1 and a wall surface (not depicted in the drawing), to which the first fitting part 1 is attached. To this end, both terminal sections 15, 16 of the first fitting part 1 are offset to such a degree, relative to the central section 14, that the flat pocket 13, in which the guide plate 12 can be slid, is formed under the central section 14 and the wall surface.

The second fitting part 2 is connected with attachment plate 19, which exhibits boreholes for screws 20 by a hinge 17 with hinge axis 18, which runs parallel to the axis of the threaded spindle 5, so as to be capable of rotation.

The first fitting part 1 is also equipped with boreholes for screws 21. The fitting that is depicted can be used as a door hinge whose height can be adjusted in such a manner that the first fitting part 1 is attached to a doorframe or door casement by its screw boreholes 21, whereas the attachment plate 19 is screwed onto a door leaf by way of its boreholes 20. By rotating the threaded spindle 5 by the head 10, the door's elevation can then be adjusted.

However, it is also possible by this fitting to connect to one another two furniture components or structural components that are arranged at an angle to one another such that their elevation can be adjusted, without employing the capacity of hinge 17 to rotate in the process. For example, the front plate of a piece of furniture can be connected by two fittings of the embodiment depicted to a furniture drawer so that its elevation may be adjusted.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

1. A furniture or structural fitting comprising a first fitting part and a second fitting part connected to the first fitting part by an elevation adjustment apparatus, such that on the first fitting part a threaded spindle is seated in two bearings arranged at a distance from one another, so as to be capable of rotation, but incapable of being repositioned axially, such that a threaded sleeve that is connected to the second fitting part is engaged with the threaded spindle between the two bearings so that its axial position may be adjusted, and the second fitting part is guided by a longitudinal guiding apparatus on the first fitting part so as to be incapable of being rotated.

2. A furniture or structural fitting according to claim 1, wherein the longitudinal guiding apparatus includes at least one guide plate that is rigidly connected to the second fitting part and is accommodated in a flat pocket, formed by the first fitting part such that a position of the at least one guide plate may be shifted longitudinally.

3. A furniture or structural fitting according to claim 2, wherein the pocket is formed between a central section of the first fitting part and a wall surface to which the first fitting part is attached.

4. A furniture or structural fitting according to claim 1, wherein the second fitting part is connected, by way of a hinge having a hinge axis that runs parallel to the axis of the threaded spindle, with an attachment plate, so as to be capable of rotating.

5. A furniture or structural fitting according to claim 1, wherein the threaded spindle is axially supported at both ends in opposite directions on the bearings in each case.

6. A furniture or structural fitting according to claim 2, wherein the threaded spindle includes, at both ends, outside the bearings in each case, a thickened head.

7. A furniture or structural fitting according to claim 3, wherein one of the two heads of the threaded spindle exhibits a wrench projection profile.

8. A furniture or structural fitting according to claim 4, wherein the wrench projection profile is one of an internal hexagonal profile, a cross-slit and a transverse slit.
